(19) United States
(12) Patent Application Publication
(10) Pub. No.: US 2025/0249592 A1
(43) Pub. Date: Aug. 7, 2025

(54) POSE CORRECTION FOR ROBOTICS

(71) Applicant: Intrinsic Innovation LLC, Mountain View, CA (US)

(72) Inventors: Wenzhao Lian, Fremont, CA (US); Stefan Schaal, Mountain View, CA (US); Maximilian Alexander Knaller, San Francisco, CA (US)

(21) Appl. No.: 18/431,810

(22) Filed: Feb. 2, 2024

(51) Int. Cl. B25J 9/16; B25J 19/02; G06N 20/00

(52) U.S. Cl. CPC B25J 9/1697; B25J 9/163; B25J 9/1633; B25J 19/023; G06N 20/00

(57) ABSTRACT

Methods, systems, and apparatus, including computer programs encoded on computer storage media, for performing pose correction. One of the methods includes receiving a plurality of images of an object held by a robotic component, wherein each image is associated with a respective perturbation pose of the robotic component that is at an offset relative to a nominal pose; generating a plurality of training examples, wherein each training example includes one or more of the plurality of images and data representing an offset between a perturbation pose associated with the one or more images and the nominal pose; and training a machine learning model that is configured to map an input comprising one or more images of an object to an output comprising data representing the offset between the perturbation pose of the robotic component and the nominal pose.

### BACKGROUND

This specification relates to robotics, and more particularly to planning and executing robotic movements.

Robotics planning refers to scheduling the physical movements of robots in order to perform tasks. For example, an industrial robot that builds cars can be programmed to first pick up a car part and then weld the car part onto the frame of the car. Each of these actions can themselves include dozens or hundreds of individual movements by robot motors and actuators.

Robotics planning has traditionally required immense amounts of manual programming in order to meticulously dictate how the robotic components should move in order to accomplish a particular task. Manual programming is tedious, time-consuming, and error prone.

In particular, grasping a part in the correct orientation and position for a following downstream manipulation step may require immense amounts of manual programming and positioning. Conventional techniques for ensuring that a robotic component grasps a part in the correct orientation and position include using specialized fixture holders for the part. The specialized fixture holders allow the robotic component to grasp the part at the same orientation and position in which the fixture holders hold the part. However, the fixture holders are often specialized for each part. Thus a specialized fixture holder may have to be built for each new part or downstream manipulation step, adding a significant burden and expense for performing different tasks or using different parts.

Other conventional techniques for ensuring that a robotic component grasps a part in the correct orientation and position include capturing an image of the part after the part has been grasped, and estimating the orientation and position of the part from the image. However, in many situations, the part is heavily occluded by the robotic component, leading to low-quality estimates of the orientation and position of the part. In addition, the robotic component has to move into the range of a camera and stop movement in order for the camera to take the image, adding time and complexity to the robotics task.

### SUMMARY

This specification describes how a system can train a machine learning model to map images of an object to data representing the offset between the pose of the robotic component and a nominal pose for the robotic component. Given images of an object, the system can then generate commands to move a robotic component to adjust the pose of the robotic component. The system can provide the images to the machine learning model that is configured to map images of an object to data representing the offset between the pose of the robotic component and a nominal pose for the robotic component. The system can generate commands to reduce the offset between the pose of the robotic component and the nominal pose.

In this specification, a pose of an object is the orientation and position of the object relative to a second object for a downstream manipulation step. The pose of an object can be defined by translation and orientation. For example, the pose can be defined in x, y, and z translation, and roll, pitch, and yaw rotation. Each object can have an associated goal pose for each downstream manipulation step. The nature of the goal pose will depend on the particular downstream task. One example of a goal pose is a bottleneck pose, which is commonly used for connector insertion tasks. In this specification, a bottleneck pose is the pose in which the object can be directly moved by a robotic component to complete a following downstream manipulation step. For example, the bottleneck pose for a USB connector where the following downstream manipulation step is to insert the USB connector into a USB socket can be a position directly above the USB port, where the USB connector is oriented to slide into the USB port. The examples in this specification that relate to connector insertion tasks may refer to bottleneck poses, but similar techniques can be used for any appropriate goal pose in other contexts.

A pose of a robotic component is the orientation and position of the robotic component relative to an object the robotic component can use to perform a downstream manipulation step. The pose of a robotic component can be defined by translation and orientation. For example, the pose can be defined in x, y, and z translation, and roll, pitch, and yaw rotation. Each robotic component can have an associated nominal pose for each downstream manipulation step and object. The nominal pose for a robotic component is the pose in which the robotic component can directly move to complete a following manipulation step. That is, the robotic component is holding the object in the object's goal pose at a position where the robotic component can directly move to complete the following manipulation step. For example, for the connector insertion task described above, the nominal pose for the robotic component is the pose of the robotic component relative to the USB connector when the USB connector is in its bottleneck pose.

Particular embodiments of the subject matter described in this specification can be implemented so as to realize one or more of the following advantages.

A system that can train a machine learning model to map images of an object to data representing the offset between the pose of the robotic component and the nominal pose for the robotic component can allow for flexibility in the types of objects that a robotic component can grasp, and the types of downstream manipulation steps that a robotic component can perform with the objects. For example, the system can receive multiple images of an object held by the robotic component. Each image can be associated with a pose of the robotic component that is at an offset relative to a nominal pose for the robotic component. The system can generate training examples, where each training example includes the images of the object and data representing the offset between the pose of the robotic component relative to the object in the images and the nominal pose for the object. The system can train the machine learning model by providing the training example as input to the machine learning model. The system can thus generate training examples and train the machine learning model for different objects and downstream manipulation steps. For example, the system can take images of each object at poses that are at different offsets relative to the robotic component. The system can also generate training examples and train the machine learning model for different goal poses for different downstream manipulation steps. For example, the system can take images of an object at poses that are at different offsets relative to the robotic component. The system can thus provide for pose correction for different types of objects and downstream manipulation steps without having to design and build a specialized fixture holder for each new object or downstream manipulation step.

The system can also provide for efficient training of the machine learning model. For example, the system can generate training examples, where each training example includes data representing the offset of a perturbation pose of the robotic component and one or more images of the object when the robotic component is at the perturbation pose. The system can obtain the nominal pose for the robotic component. The system can move the robotic component to different perturbation poses that are at different offsets relative to the nominal pose. The system can receive one or more images of the object for each offset of the different offsets. The system can thus autonomously and efficiently obtain large numbers of training examples by moving the robotic component and taking images of the object.

The system can train the machine learning model using a variety of types of inputs, providing more information for the machine learning model to learn from and increasing accuracy. For example, an image of a training example can be an optical image, data derived from an optical image, a tactile image, or data derived from a tactile image. Furthermore, each training example can include more than one type of image. Providing more types of information can allow the machine learning model to make more accurate predictions.

The system can provide for faster pose correction than conventional techniques. For example, to perform pose correction for an object being held by a robotic component, the system can provide an input that includes images of the object to a machine learning model that is configured to map images of an object to data representing the offset between the pose of the robotic component and the nominal pose. The system can generate data representing commands to move the robotic component to reduce the offset of the pose of the robotic component relative to the nominal pose so that the object is closer to the goal pose. The system does not require the robotic component to move the object to a specific location for an image to be taken, reducing the amount of time needed to perform pose correction and speeding up the robotic task.

The system can also provide for more accurate pose correction than conventional techniques. For example, conventional techniques that use optical images of an object may perform poorly when the object is heavily occluded by the robotic component. For example, the robotic component may cover the object so that the object is not visible. The system described in this specification can use other types of data, such as tactile images, to perform pose correction. The system can thus provide for more accurate pose correction by using different or multiple types of data for the object.

Furthermore, the system can provide for pose correction without having to train the machine learning model on training data that can be computationally expensive to generate, such as computer-aided design (CAD) models. The system can train the machine learning model on perceptual training data such as computer vision images or tactile images, allowing for a high precision of pose correction for any robotic task.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram that illustrates an example system.

FIGS. 2A-2C depict a diagram of a process for obtaining a bottleneck pose for an object.

FIGS. 3A-3F are example images of an object at different poses.

FIG. 4 is a flowchart of an example process for training a machine learning model to map an image of an object to data representing the offset between the pose of the robotic component and a nominal pose.

FIG. 5 is a flowchart of an example process for generating correction data representing commands to perform pose correction.

Like reference numbers and designations in the various drawings indicate like elements.

### DETAILED DESCRIPTION

This specification describes how a system can train a machine learning model to map images of an object to data representing the offset between the pose of the robotic component and a nominal pose. This specification also describes how a system can use a trained machine learning model to perform pose correction.

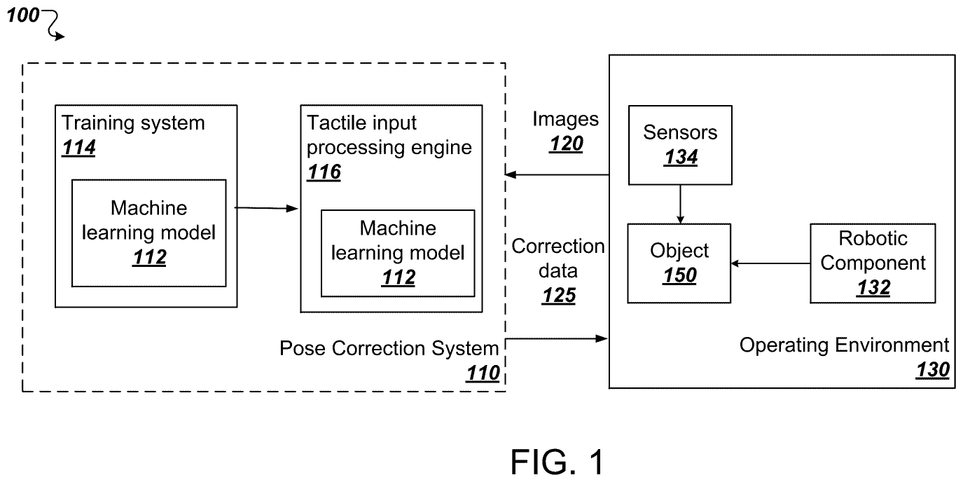

FIG. 1 is a diagram that illustrates an example system 100. The system 100 is an example of a system that can implement the training and pose correction techniques described in this specification.

The system 100 includes a pose correction system 110 and an operating environment 130. The pose correction system 110 can receive data such as images 120 from the operating environment 130. The operating environment 130 can receive correction data 125 for a robotic component 132 from the pose correction system 110. The pose correction system 110 and the operating environment 130 can be coupled to each other through any appropriate communications network, e.g., an intranet or the Internet, or combination of networks.

The operating environment 130 can include a robotic component 132 and a sensor 134. The robotic component 132 can be part of a robot that is configured to perform a robotics task. The robotic component 132 can be configured to perform one or more steps in the robotics task. For example, the robotic component 132 can be configured to pick up an object 150 and perform a downstream manipulation step using the object 150. The sensor 134 can be configured to gather data at a location relative to the robotic component 132. The sensor 134 can be an optical camera or a tactile camera, for example. An optical camera captures visible-light features and generates visible-light images. A tactile camera captures tactile information by converting tactile features into light, and generating tactile images from the light. The sensor 134 can also be another type of camera such as a polarization camera. In some implementations, the operating environment 130 can include multiple sensors such as the sensor 134. In some implementations, the sensors can be of different types or located in different locations relative to the object 150 and the robotic component 132.

The pose correction system 110 includes multiple components such as a training system 114 and a tactile input processing engine 116. Each of these components can be implemented as computer programs installed on one or more computers in one or more locations that are coupled to each other through any appropriate communications network, e.g., an intranet or the Internet, or combination of networks.

The training system 114 is configured to train machine learning models such as machine learning model 112. The training system 114 can generate model parameters for the machine learning model 112 such that the predictions that the machine learning model 112 generates given an input of images most closely match the pose of the robotic component relative to the pose of the object depicted in the images. For example, the training system 114 can be configured to receive multiple images 120 of the object 150 held by the robotic component 132. Each image in images 120 can be associated with a pose of the robotic component 132 that is at an offset relative to a nominal pose for the robotic component 132. In some examples, multiple images in images 120 can be associated with the same pose. For example, the multiple images that are associated with the same pose can be images of different types.

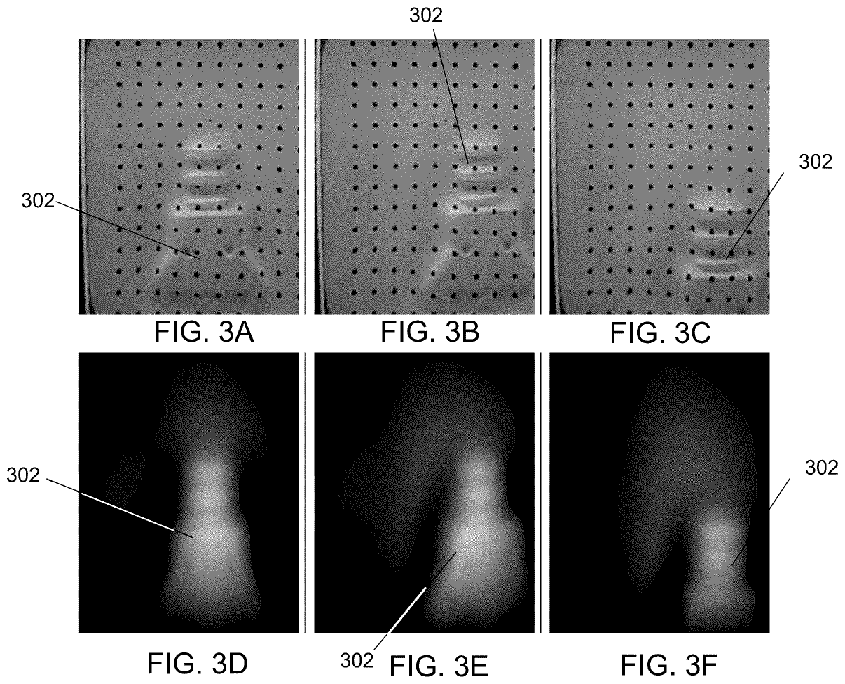

Each image in images 120 can include a 2-dimensional array of values. The values can represent, for example, optical camera data, tactile sensor data, polarization camera data, etc. The images can thus include optical images, data derived from optical images, computer vision images, tactile images, or data derived from tactile images. Example images are shown below in FIGS. 3A-3F.

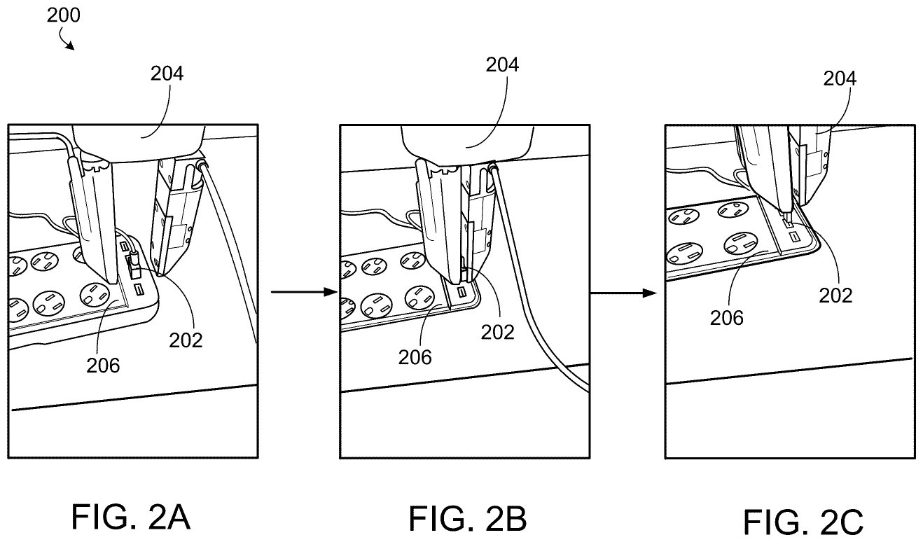

In some implementations, the training system 114 can send commands to the robotic component 132 and one or more sensors 134 to generate the images 120. For example, the training system 114 can obtain a nominal pose for the robotic component 132. The nominal pose for the robotic component 132 can indicate that the robotic component 132 is holding the object 150 in its goal pose and the robotic component 132 is in a position to directly complete the following downstream manipulation step. An example goal pose that is a bottleneck pose for the object 150, and an example nominal pose for the robotic component 132, are described with reference to FIG. 2C.

The training system 114 can determine multiple offsets within a threshold of the nominal pose. For example, each offset can differ in translation, roll rotation, pitch, and/or yaw from the nominal pose. The amount that each offset differs from the nominal pose can be less than or equal to the threshold. The threshold can be different for translation, roll rotation, pitch, and yaw. For example, the threshold for x-translation can be 1 mm, while the threshold for z-translation can be 5 mm. The threshold can also be different for different downstream manipulation steps. For example, steps such as inserting a USB connector may have higher error tolerance than inserting a screw. In some implementations, the training system can randomly sample within the thresholds for translation, roll rotation, pitch, and/or yaw to generate different offsets.

For each offset, the training system 114 can cause the robotic component 132 to move to a perturbation pose that is at the offset relative to the nominal pose. For example, the object 150 can remain in a fixed pose and location relative to a base of the robotic component. The training system 114 can send commands to the robotic component 132 to move the robotic component 132 to a perturbation pose relative to the base of the robotic component so that the robotic component 132 is at the offset relative to the fixed location of the object 150. The training system 114 can send commands to the sensor 134 to take an image of the object 150. For example, upon moving so that the robotic component 132 is at the offset, the robotic component 132 can send confirmation data indicating that the robotic component 132 is at the offset to the training system 114. The training system 114 can then send commands to the one or more sensors 134 to take images of the object 150.

The training system 114 can receive the one or more images 120 from the sensors 134. The one or more images 120 can include different types of images. For example, the sensors 134 can include different types of sensors, and take images of different types.

For each offset, the training system 114 can obtain data representing the offset of the perturbation pose relative to the nominal pose. For example, for each offset, the training system 114 can generate the data representing the offset of the perturbation pose relative to the nominal pose given data representing the fixed pose and location of the object 150 relative to the base of the robotic component, data representing the perturbation pose relative to the base of the robotic component, and data representing the nominal pose relative to the base of the robotic component. The offset of the perturbation pose relative to the nominal pose can be derived from data representing the perturbation pose relative to the base of the robotic component and data representing the nominal pose relative to the base of the robotic component, and the data representing the nominal pose relative to the base of the component can be derived from the data representing the pose of the robotic component relative to the object 150, and the fixed pose of the object 150 relative to the base of the robotic component.

The training system 114 can generate multiple training examples. Each training example can include one or more of the multiple images 120, and data representing an offset between the perturbation pose associated with the one or more images and the nominal pose. In some implementations, the one or more images of a training example can include different types of images. In some implementations, the training system 114 can include different combinations of the different types of images. For example, the training system 114 can generate multiple training examples for a particular pose, where each training example includes a different combination of types of images. Including different combinations of types of images can help train the machine learning model 112 to be more robust against types of images that may be less accurate than other types of images.

The training system 114 can train the machine learning model 112 to map an input that includes one or more images of an object to data representing the offset between the pose and the nominal pose. For example, the training system 114 can provide the multiple training examples to the machine learning model 112 as input. The training system 114 can split the multiple training examples into a training set and validation set. For example, the training set can include 80% of the training examples, and the validation set can include 20% of the training examples. The training system 114 can train the machine learning model 112 in a self-supervised manner. In some implementations, the training system 114 can use an Adam optimizer to train the machine learning model 112. The training system 114 can perform hyperparameter tuning on hyperparameters such as learning rate, batch size, and weight decay.

The machine learning model 112 can be a neural network with multiple layers such as a recurrent neural network (RNN) or convolutional neural network (CNN), for example. For example, the machine learning model 112 can be a residual network.

After training the machine learning model 112, the training system 114 can provide the machine learning model 112 to the tactile input processing engine 116 as trained machine learning model 113. That is, the machine learning model 113 is the machine learning model 112 that has been trained to map an input including one or more images of an object to an output including data representing the offset between the perturbation pose of the robotic component and the nominal pose for the robotic component.

The system 100 can use the tactile input processing engine 116 at inference time to perform pose correction. The tactile input processing engine 116 can provide inputs that include images 120 to the trained machine learning model 113. In some implementations, the trained machine learning model 113 can have been trained by the system as described above. For example, the tactile input processing engine 116 can receive the trained machine learning model 113 from the training system 114. In some implementations, the system 100 can obtain a trained machine learning model 113.

As described above, the trained machine learning model 113 is configured to map an input that includes one or more images of an object to an output that includes data representing the offset between the perturbation pose of the robotic component and the nominal pose for the robotic component.

The tactile input processing engine 116 can receive one or more images 120 of the object 150 held by the robotic component 132. Each image can be associated with a pose of the robotic component 132 that is at an offset relative to the nominal pose for the robotic component 132. The tactile input processing engine 116 can provide the one or more images 120 as input to the trained machine learning model 113. The trained machine learning model 113 can output data representing the predicted offset between the pose of the robotic component 132 and the nominal pose of the robotic component 132.

Based on the output of the trained machine learning model 113, the tactile input processing engine 116 can generate correction data 125 that represents commands to move the robotic component 132. The commands can cause the robotic component 132 to move in a manner that causes the offset of the pose of the robotic component 132 to be reduced relative to the nominal pose. Moving the robotic component 132 closer to the nominal pose also moves the object 150 closer to its goal pose. That is, the commands move the robotic component 132 so that the pose of the object 150 is closer to the goal pose for the object 150. For example, if the output of the trained machine learning model 113 indicates that the z-translation of the object 150 is too high compared to the z-translation of the object 150 in the nominal pose, i.e., the robotic component 132 is holding the object 150 too high to perform the downstream manipulation step, the pose correction system 110 can determine commands that cause the robotic component 132 to move so that the robotic component 132 holds the object 150 lower. By holding the object 150 lower, the object 150 gets closer to the goal pose for the object 150. Thus the system 100 can generate correction data 125 for the robotic component 132 given one or more images 120 of the object 150.

Upon receiving the correction data 125, the robotic component 132 can perform the commands that causes the offset of the pose of the object 150 relative to the goal pose for the object 150 to be reduced. The pose correction system 110 can thus be used to perform pose correction.

FIGS. 2A-2C depict a diagram of a process 200 for obtaining a goal pose that is a bottleneck pose for an object 202. In some implementations, a system such as the system 100 of FIG. 1 can determine the bottleneck pose for a given object. FIGS. 2A, 2B, and 2C show a robotic component 204 in various configurations relative to the object 202. In FIGS. 2A, 2B, and 2C, the robotic component 204 is a robotic gripper and the object 202 is a USB connector. The downstream manipulation step for the robotic gripper can be a connector insertion task, i.e., to insert the USB connector into a holder object 206 such as a USB port.

FIG. 2A shows the object 202 inserted into the holder object 206. That is, the image 210 shows an example of the object 202 after the downstream manipulation step has been completed. The robotic component 204 is not in contact with the object 202. The object 202 can have been inserted into the holder object 206 manually, for example.

FIG. 2B shows the robotic component 204 holding the object 202 while it is inserted into the holder object 206 as depicted in image 210. For example, the system can be configured to maneuver the robotic component 204 into a configuration that allows the robotic component 204 to hold or grasp the object 202.

FIG. 2C shows the robotic component 204 holding the object 202 at the bottleneck pose for the object 202. FIG. 2C also shows the robotic component 204 in the nominal pose for the object 202. That is, the image 230 shows the robotic component 204 holding the object 202 in the pose in which the object 202 can be directly moved to complete the downstream manipulation step of inserting the object 202 into the holder object 206. For example, from the position of the robotic component 204 and the object 202 depicted in image 220, the system can be configured to maneuver the robotic component 204 linearly out of the holder object 206. In the example of image 230, the robotic gripper can move the USB connector linearly away from the USB port, i.e., in an upwards motion, to remove the USB connector from the USB port.

The system can generate data representing the bottleneck pose for the object 202 and the nominal pose for the robotic component 204. For example, the system can save data representing translation and orientation of the bottleneck pose relative to the robotic component 204. The system can also save data representing translation and orientation of the nominal pose relative to the object 202. The system can save the data representing the nominal pose for the robotic component 204 and the bottleneck pose for the object 202 in order to generate training examples for training a machine learning model such as the machine learning model 112 of FIG. 1. The system can also use the data representing the nominal pose and the data representing the bottleneck pose for the object 202 to generate correction data to perform pose correction.

The system can store the data representing the nominal pose and the data representing the bottleneck pose for the object 202 in a database, for example. The database can include bottleneck poses for different objects and different downstream manipulation steps. The database can include nominal poses for different types of robotic components and different objects. Thus, for a given object, robotic component, and downstream manipulation step, the system can determine whether the bottleneck pose and/or the nominal pose is already known by accessing the database. If the bottleneck pose or the nominal pose is not already known, the system can obtain the bottleneck pose or nominal pose by performing the process 200, for example. If the bottleneck pose or nominal pose is already known, the system can obtain the bottleneck pose or nominal pose from the database, reducing the computing time it would take to determine the bottleneck pose or nominal pose.

FIGS. 3A-3F are example images of an object 302 at different poses. In FIGS. 3A-3F, the object 302 is an electrical plug. A robotic component such as the robotic component 204 can be a gripper for the electrical plug. An example downstream manipulation step for the robotic component can be a connector insertion task, i.e., to insert the electrical plug into an electrical socket. FIGS. 3A-3F can be examples of the images 120 that are received by the pose correction system to train a machine learning model, or to provide to the machine learning model to perform pose correction.

FIGS. 3A-3C are example raw tactile images. For example, a tactile image can represent tactile information about the subject of the image. The images of FIGS. 3A-3C can be obtained from a tactile image sensor. The tactile image sensor can be positioned on the robotic component, for example.

FIGS. 3D-3F are examples of data derived from tactile images. The images of FIGS. 3D-3F include depth maps computed from the tactile images of FIGS. 3A-3C. For example, FIG. 3D can be a depth map computed from FIG. 3A. FIG. 3E can be a depth map computed from FIG. 3B. FIG. 3F can be a depth map computed from FIG. 3C. The depth map can represent distance or depth information of the subject of the image relative to the tactile image sensor. In some implementations, the tactile image sensor can generate a corresponding depth map for each raw tactile image. In some implementations, the pose correction system can generate a corresponding depth map for each raw tactile image received from the tactile image sensor.

In some implementations, the images can also include optical images such as RGB images, or data derived from optical images. Examples of data derived from optical images can include color histograms, surface normals, or information about edges. In some implementations, the machine learning model can be trained on and receive inputs that include embeddings of images or data derived from the images.

Each of the poses shown in FIG. 3A-3F can be defined by translation and orientation. For example, each pose can be defined in any one or more of x, y, and z translation, and roll, pitch, and yaw rotation. In some examples, translation and orientation can be defined as an offset from the pose of the object in the nominal pose. The pose of the object 302 in FIG. 3A and FIG. 3D, for example, can be defined by [0, 0, 0], or an offset from the pose of the object when the robotic component is in the nominal pose of 0 mm for y-translation, 0 mm for z-translation, and 0 radians for roll rotation. For example, FIG. 3A and FIG. 3D can depict the object when the robotic component is in the nominal pose.

The pose of the object 302 in FIG. 3E and FIG. 3B, for example, can be defined by [3.860, 0.129, and −0.0419], or an offset from the pose of the object in the nominal pose of 3.860 mm for y-translation, 0.129 mm for z-translation, and −0.0419 radians for roll rotation. The pose of the object 302 in FIG. 3F and FIG. 3C, for example, can be defined by [4.411, −5.368, and 0.0264], or an offset from the pose of the object in the nominal pose of 4.411 mm for y-translation, −5.368 mm for z-translation, and 0.0264 radians for roll rotation.

In some examples, as described above with reference to FIG. 1, a training system such as the training system 114 of FIG. 1 can determine multiple offsets within a threshold of the nominal pose. For example, the training system can determine an offset of 3.860 mm for y-translation, 0.129 mm for z-translation, and −0.0419 radians for roll rotation. The training system can also determine offsets of 4.411 mm for y-translation, −5.368 mm for z-translation, and 0.0264 radians for roll rotation. For each offset, the training system can obtain data representing the offset of the pose relative to the nominal pose. For example, the training system can generate a set of data such as [3.860, 0.129, and −0.0419] that defines the pose shown in images 320 and 350. The training system can generate a set of data such as [4.411, −5.368, and 0.0264] that defines the pose shown in images 330 and 360. For each offset, the training system 114 can cause the robotic component to move so that it is at the pose that is at the offset from the nominal pose. The training system can receive one or more images of the object 302 at each offset and generate training examples to train the machine learning model.

In some examples, FIGS. 3A-3F can be images received by the pose correction system to provide as input to the machine learning model. The pose correction system can provide the images as input to the machine learning model, and receive an output that includes data representing the offset between the pose of the robotic component and the nominal pose for the robotic component.

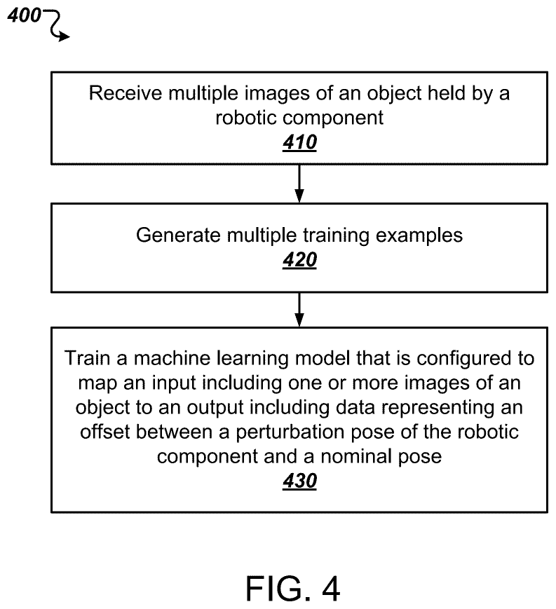

FIG. 4 is a flowchart of an example process 400 for training a machine learning model to map an image of an object to data representing the offset between the pose of the robotic component and a nominal pose for the robotic component. The process 400 can be performed by a system such as the training system 114 of FIG. 1.

The system receives multiple images of an object held by a robotic component (step 410). Each image can be associated with a respective perturbation pose of the robotic component that is at an offset relative to a nominal pose. The multiple images can include images of different types. For example, the types of images can include an optical image, data derived from an optical image, a tactile image, or data derived from a tactile image.

In some implementations, the system can generate the multiple images. For example, the system can obtain the nominal pose for the object as described above with reference to FIGS. 2A-2C. For multiple offsets within a threshold of the nominal pose for the object, the system can cause the robotic component to move to a perturbation pose that is at the offset relative to the nominal pose. For example, the system can generate commands that move the robotic component so that the robotic component moves to the perturbation pose. The system can obtain data representing the offset of the perturbation pose relative to the nominal pose. For example, the system can obtain data representing the translation or orientation of the perturbation pose relative to a base of the robotic component, data representing the translation or orientation of the object relative to the robotic component, and data representing the nominal pose. The system can then generate commands that cause sensors to take one or more images of the object. The system can thus receive one or more images of the object, where the one or more images depict the object at different poses relative to the robotic component. In some implementations, the one or more images can include different types of images.

The system generates multiple training examples (step 420). Each training example can include one or more of the multiple images, and data representing an offset between a perturbation pose associated with the one or more images and the nominal pose for the object. The offset can include an offset in translation, roll rotation, pitch, and/or yaw. In some implementations, the one or more images of a training example can include different types of images. For example, the training example can include an optical image and a tactile image.

The system trains a machine learning model that is configured to map an input including one or more images of an object to an output including data representing an offset between a perturbation pose of the robotic component and the nominal pose (step 430). For example, the system can provide the multiple training examples to the machine learning model as input.

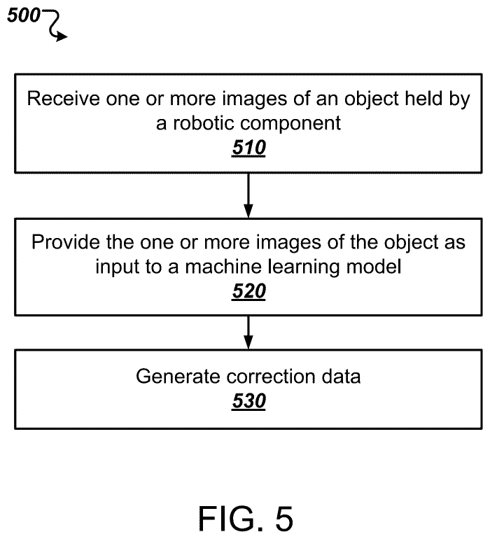

FIG. 5 is a flowchart of an example process 500 for generating correction data representing commands to perform pose correction. The process 500 can be performed by a system such as the pose correction system 110 of FIG. 1.

The system receives one or more images of an object held by a robotic component (step 510). Each image can be associated with a respective perturbation pose of the robotic component that is at an offset relative to a nominal pose. For example, one or more of the images can depict the object in a different pose, i.e., at a different offset relative to the robotic component. The one or more images can be different types of images. For example, the images can include an optical image, data derived from an optical image, a tactile image, or data derived from a tactile image.

The system provides the one or more images of the object as input to a machine learning model (step 520). The machine learning model can be configured to map an input including one or more images of an object to an output including data representing the offset between a perturbation pose of the robotic component and the nominal pose. The machine learning model can have been trained through the process 400 of FIG. 4, for example. The offset between the perturbation pose and the nominal pose can include an offset in translation, roll rotation, pitch, and/or yaw.

The system generates correction data (step 530). The correction data can represent commands to move the robotic component based on the output of the machine learning model to reduce the offset of the perturbation pose relative to the nominal pose. For example, the system can send commands to the robotic component that move the robotic component in a manner that causes the pose of the object to be closer to the goal pose.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:
Embodiment 1 is a method comprising:
receiving a plurality of images of an object held by a robotic component, wherein each image is associated with a respective perturbation pose of the robotic component that is at an offset relative to a nominal pose;
generating a plurality of training examples, wherein each training example includes one or more of the plurality of images and data representing an offset between a perturbation pose associated with the one or more images and the nominal pose; and
training a machine learning model that is configured to map an input comprising one or more images of an object to an output comprising data representing the offset between the perturbation pose of the robotic component and the nominal pose by providing the plurality of training examples to the machine learning model as input.
Embodiment 2 is the method of embodiment 1, wherein the offset between the perturbation pose of the robotic component and the nominal pose comprises an offset in any one of: translation, roll rotation, pitch, or yaw.
Embodiment 3 is the method of any one of embodiments 1-2, wherein a type of each image comprises any one of: an optical image, data derived from an optical image, a tactile image, or data derived from a tactile image.
Embodiment 4 is the method of any one of embodiments 1-3, wherein the one or more images of a training example comprise different types of images.
Embodiment 5 is the method of any one of embodiments 1-4, wherein receiving a plurality of images comprises:
obtaining the nominal pose for the robotic component;
for a plurality of perturbation poses within a threshold of the nominal pose:
   causing the robotic component to move to the perturbation pose;
   obtaining data representing the offset of the perturbation pose relative to the nominal pose; and
   receiving one or more images of the object.
Embodiment 6 is the method of embodiment 5, wherein the one or more images comprise different types of images of the object.
Embodiment 7 is a method comprising:
receiving one or more images of an object held by a robotic component, wherein each image is associated with a respective perturbation pose of the robotic component that is at an offset relative to a nominal pose;
providing the one or more images of the object as input to a machine learning model that is configured to map an input comprising one or more images of an object to an output comprising data representing the offset between a perturbation pose of the robotic component and the nominal pose; and
generating correction data representing commands to move the robotic component based on the output to reduce the offset of the perturbation pose relative to the nominal pose so that the object is closer to a goal pose.
Embodiment 8 is the method of embodiment 7, wherein the offset between the perturbation pose of the robotic component and the nominal pose comprises an offset in any one of: translation, roll rotation, pitch, or yaw.
Embodiment 9 is the method of any one of embodiments 7-8, wherein a type of each image comprises any one of: an optical image, data derived from an optical image, a tactile image, or data derived from a tactile image.
Embodiment 10 is a system comprising: one or more computers and one or more storage devices storing instructions that are operable, when executed by the one or more computers, to cause the one or more computers to perform the method of any one of embodiments 1 to 9.
Embodiment 11 is a computer storage medium encoded with a computer program, the program comprising instructions that are operable, when executed by data processing apparatus, to cause the data processing apparatus to perform the method of any one of embodiments 1 to 9.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
receiving a plurality of images of an object held by a robotic component, wherein each image is associated with a respective perturbation pose of the robotic component that is at an offset relative to a nominal pose;
generating a plurality of training examples, wherein each training example includes one or more of the plurality of images and data representing an offset between a perturbation pose associated with the one or more images and the nominal pose; and
training a machine learning model that is configured to map an input comprising one or more images of an object to an output comprising data representing the offset between the perturbation pose of the robotic component and the nominal pose by providing the plurality of training examples to the machine learning model as input.

2. The method of claim 1, wherein the offset between the perturbation pose of the robotic component and the nominal pose comprises an offset in any one of: translation, roll rotation, pitch, or yaw.

3. The method of claim 1, wherein a type of each image comprises any one of: an optical image, data derived from an optical image, a tactile image, or data derived from a tactile image.

4. The method of claim 1, wherein the one or more images of a training example comprise different types of images.

5. The method of claim 1, wherein receiving a plurality of images comprises:
obtaining the nominal pose for the robotic component;
for a plurality of perturbation poses within a threshold of the nominal pose:
causing the robotic component to move to the perturbation pose;
obtaining data representing the offset of the perturbation pose relative to the nominal pose; and
receiving one or more images of the object.

6. The method of claim 5, wherein the one or more images comprise different types of images of the object.

7. A method comprising:
receiving one or more images of an object held by a robotic component, wherein each image is associated with a respective perturbation pose of the robotic component that is at an offset relative to a nominal pose;
providing the one or more images of the object as input to a machine learning model that is configured to map an input comprising one or more images of an object to an output comprising data representing the offset between a perturbation pose of the robotic component and the nominal pose; and
generating correction data representing commands to move the robotic component based on the output to reduce the offset of the perturbation pose relative to the nominal pose so that the object is closer to a goal pose.

8. The method of claim 7, wherein the offset between the perturbation pose of the robotic component and the nominal pose comprises an offset in any one of: translation, roll rotation, pitch, or yaw.

9. The method of claim 7, wherein a type of each image comprises any one of: an optical image, data derived from an optical image, a tactile image, or data derived from a tactile image.

10. A system comprising:
one or more computers; and
one or more storage devices storing instructions that are operable, when executed by the one or more computers, to cause the one or more computers to perform operations comprising:
receiving a plurality of images of an object held by a robotic component, wherein each image is associated with a respective perturbation pose of the robotic component that is at an offset relative to a nominal pose;
generating a plurality of training examples, wherein each training example includes one or more of the plurality of images and data representing an offset between a perturbation pose associated with the one or more images and the nominal pose; and
training a machine learning model that is configured to map an input comprising one or more images of an object to an output comprising data representing the offset between the perturbation pose of the robotic component and the nominal pose by providing the plurality of training examples to the machine learning model as input.

11. The system of claim 10, wherein the offset between the perturbation pose of the robotic component and the nominal pose comprises an offset in any one of: translation, roll rotation, pitch, or yaw.

12. The system of claim 10, wherein a type of each image comprises any one of: an optical image, data derived from an optical image, a tactile image, or data derived from a tactile image.

13. The system of claim 10, wherein the one or more images of a training example comprise different types of images.

14. The system of claim 10, wherein receiving a plurality of images comprises:
obtaining the nominal pose for the robotic component;
for a plurality of perturbation poses within a threshold of the nominal pose:
causing the robotic component to move to the perturbation pose;
obtaining data representing the offset of the perturbation pose relative to the nominal pose; and
receiving one or more images of the object.

15. The system of claim 14, wherein the one or more images comprise different types of images of the object.

16. A computer storage medium encoded with a computer program, the program comprising instructions that are operable, when executed by data processing apparatus, to cause the data processing apparatus to perform operations comprising:
receiving a plurality of images of an object held by a robotic component, wherein each image is associated with a respective perturbation pose of the robotic component that is at an offset relative to a nominal pose;
generating a plurality of training examples, wherein each training example includes one or more of the plurality of images and data representing an offset between a perturbation pose associated with the one or more images and the nominal pose; and
training a machine learning model that is configured to map an input comprising one or more images of an object to an output comprising data representing the offset between the perturbation pose of the robotic component and the nominal pose by providing the plurality of training examples to the machine learning model as input.

17. The computer storage medium of claim 16, wherein the offset between the perturbation pose of the robotic component and the nominal pose comprises an offset in any one of: translation, roll rotation, pitch, or yaw.

18. The computer storage medium of claim 16, wherein a type of each image comprises any one of: an optical image, data derived from an optical image, a tactile image, or data derived from a tactile image.

19. The computer storage medium of claim 16, wherein the one or more images of a training example comprise different types of images.

20. The computer storage medium of claim 16, wherein receiving a plurality of images comprises:
obtaining the nominal pose for the robotic component;
for a plurality of perturbation poses within a threshold of the nominal pose:
causing the robotic component to move to the perturbation pose;
obtaining data representing the offset of the perturbation pose relative to the nominal pose; and
receiving one or more images of the object.
